(19) United States
(12) Patent Application Publication
(10) Pub. No.: US 2016/0085494 A1
(43) Pub. Date: Mar. 24, 2016

(54) CONTROL DEVICE, PRINTING DEVICE, PORTABLE TERMINAL, CONTROL METHOD, AND NON-TRANSITORY COMPUTER READABLE MEDIUM

(71) Applicant: FUJI XEROX CO., LTD., Tokyo (JP)

(72) Inventors: Kohshiro INOMATA, Kanagawa (JP); Takashi MOMMA, Kanagawa (JP)

(21) Appl. No.: 14/607,693

(22) Filed: Jan. 28, 2015

(30) Foreign Application Priority Data
Sep. 19, 2014 (JP) 2014-191235

(51) Int. Cl. G06F 3/12; G06Q 30/02

(52) U.S. Cl. CPC G06F 3/1292; G06Q 30/0273; G06F 3/1272; G06F 3/1204

(57) ABSTRACT

A control device includes a selection unit. The selection unit selects, based on location information of a portable terminal and information of a moving speed of the portable terminal, regional information related to a region represented by the location information.

### CROSS-REFERENCE TO RELATED APPLICATIONS

This application is based on and claims priority under 35 USC 119 from Japanese Patent Application No. 2014-191235 filed Sep. 19, 2014.

### BACKGROUND

### Technical Field

The present invention relates to a control device, a printing device, a portable terminal, a control method, and a non-transitory computer readable medium.

### SUMMARY

According to an aspect of the invention, there is provided a control device including a selection unit that selects, based on location information of a portable terminal and information of a moving speed of the portable terminal, regional information related to a region represented by the location information.

### BRIEF DESCRIPTION OF THE DRAWINGS

Exemplary embodiments of the present invention will be described in detail based on the following figures, wherein:

FIG. 1 is a diagram illustrating the entire configuration of an exemplary embodiment;

FIG. 2 is a diagram illustrating a history DB;

FIG. 3 is a diagram illustrating storage contents of an advertisement DB;

FIG. 4 is a diagram illustrating a functional configuration of a control device and a printing device;

FIG. 5 is a flowchart illustrating an operation of the control device;

FIG. 6 is a diagram illustrating an example of an analysis result of history information of location information;

FIG. 7 is a diagram illustrating a hardware configuration of a portable terminal;

FIG. 8 is a diagram illustrating a functional configuration of the portable terminal;

FIG. 9 is a flowchart illustrating an operation of the portable terminal.

### DETAILED DESCRIPTION

### First Embodiment

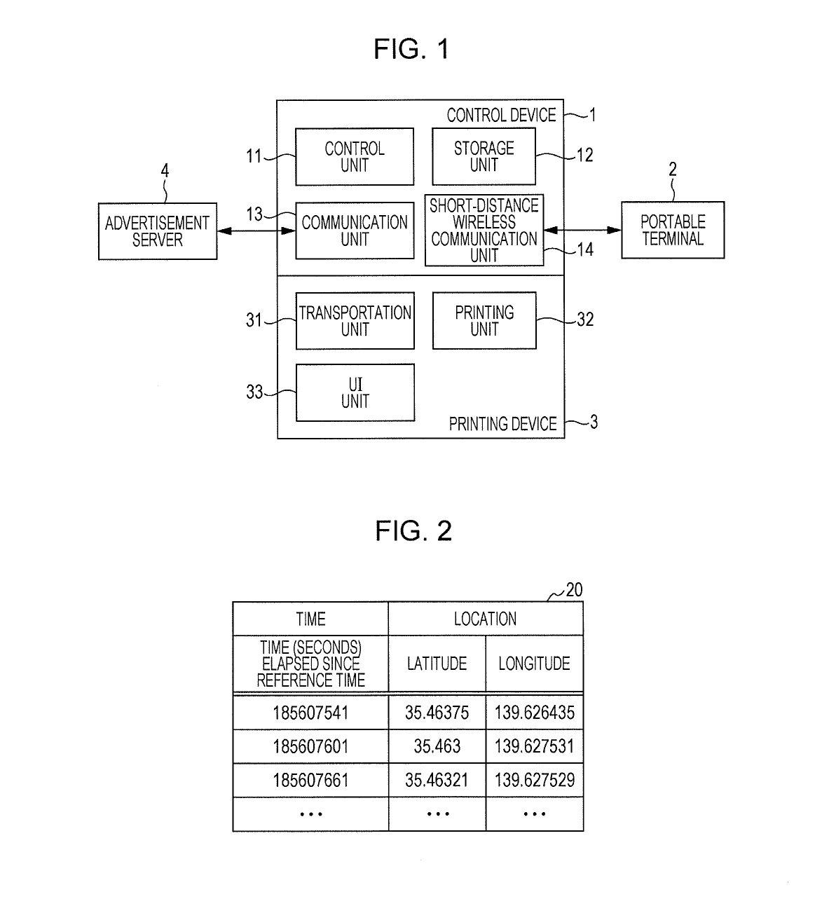

Exemplary embodiments of the present invention will be explained. FIG. 1 is a diagram illustrating a hardware configuration. A control device 1 is configured integrally with a printing device 3. The control device 1 has a function for controlling an operation of the printing device 3. A portable terminal 2 is a communication terminal, such as a portable telephone, a smartphone, or a tablet terminal carried by a user. An advertisement server 4 includes a database in which advertisement data is stored, and the like, and transmits data to the printing device 3 in accordance with a request from the printing device 3.

The printing device 3 includes a transportation unit 31, a printing unit 32, and a user interface (UI) unit 33. The transportation unit 31 picks up sheet-like recording media accommodated within an accommodation unit (not illustrated) one by one, and transports the picked up recording medium through a transport path (not illustrated). The printing unit 32 forms a toner image using, for example, an electrophotographic system, based on image data supplied from the control device 1, and transfers the toner image onto a recording medium transported through the transport path. The UI unit 33 includes a display part and a reception part (not illustrated). The display part is, for example, a liquid crystal display, and displays an operation screen to be used by a user for operation of the printing device 3. The reception part is, for example, a touch panel provided to cover the display surface of the display part. The reception part receives an operation performed by a user and outputs the contents of the operation to the control device 1.

The control device 1 includes a control unit 11, a storage unit 12, a communication unit 13, and a short-distance wireless communication unit 14. The control unit 11 includes an arithmetic device, such as a central processing unit (CPU), and a storage device, such as a read only memory (ROM) and a random access memory (RAM) (neither devices are illustrated). Hardware and firmware in which a procedure of start-up of an operating system (OS) is described are stored in the ROM. The RAM is used to store data when the CPU performs arithmetic operations. The storage unit 12 includes, for example, a hard disk storage device, and stores an OS, an application program, and the like. The communication unit 13 is a communication interface (I/F) which connects the control device 1 to the advertisement server 4 via a communication line, such as a local area network. The short-distance wireless communication unit 14 is a communication I/F for performing short-distance wireless communication with the portable terminal 2, and is, for example, a reader/writer which communicates with a non-contact integrated circuit (IC) card provided in the portable terminal 2. A mark indicating the position of the short-distance wireless communication unit 14 is provided outside the housing of the control device 1. When a user holds the portable terminal 2 over the position of the mark, short-distance wireless communication between the control device 1 and the portable terminal 2 is performed.

FIG. 2 is a diagram illustrating a history DB 20. The history DB 20 is a database in which history information of location information of the portable terminal 2 is stored. The portable terminal 2 acquires location information indicating the location of the portable terminal 2 by using a known satellite positioning system or the like, and stores the acquired location information and time in association with each other in the storage device provided in the portable terminal 2. In this example, the time elapsed since a reference time is represented as time, and the latitude and longitude is represented as the location. However, the time and location may be described in a different way. Preferably, location information is acquired at constant time intervals. Preferably, history information of location information for several weeks is stored in the history DB 20. The oldest location information may be deleted every time the latest location information is added.

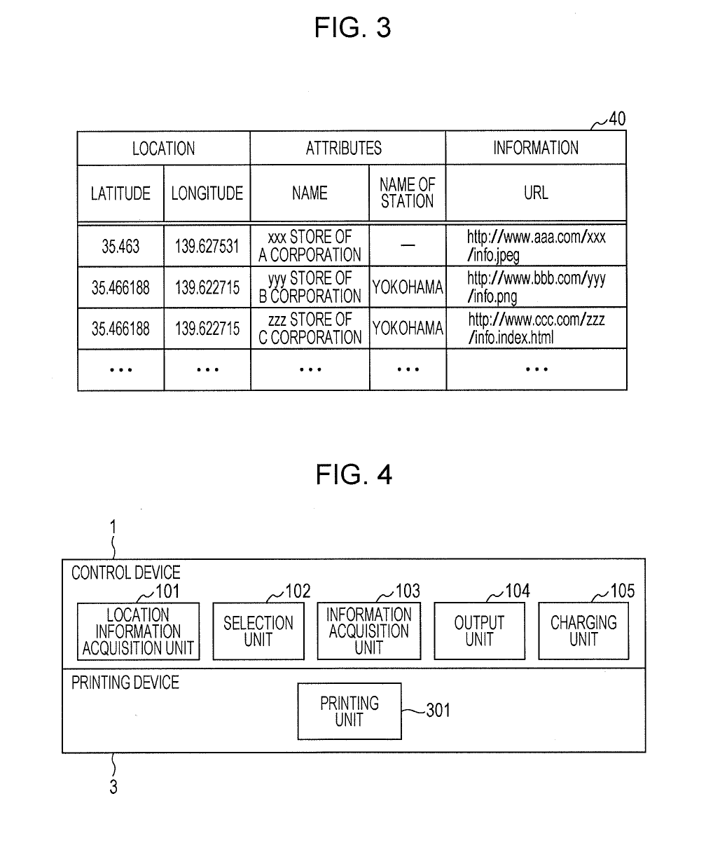

FIG. 3 is a diagram illustrating the storage contents of an advertisement DB 40. The advertisement DB 40 is a database in which advertisement data is stored, and is stored in the storage device provided in the advertisement server 4. Advertisement data used in the first exemplary embodiment is an example of regional information according to an aspect of the present invention. A record in the advertisement DB 40 has fields of location (latitude and longitude), attributes (name and name of station), and information (uniform resource locator (URL)). The latitude and longitude represents the location of a store by using latitude and longitude. The name represents the name of a store. The name of a station represents the name of a station for the case where a store is located within a station building. The URL represents the address of the location where advertisement data of a store is stored.

FIG. 4 is a diagram illustrating a functional configuration of the control device 1 and the printing device 3. The control device 1 includes a location information acquisition unit 101, a selection unit 102, an information acquisition unit 103, an output unit 104, and a charging unit 105. The printing device 3 includes a printing unit 301.

The location information acquisition unit 101 is a unit which acquires history information of location information indicating the location of the portable terminal 2. More specifically, the control device 1 receives history information of location information from the portable terminal 2 via the short-distance wireless communication unit 14. The location information acquisition unit 101 does not necessarily receive information via the short-distance wireless communication unit 14. The location information acquisition unit 101 may receive history information of location information from the portable terminal 2 via the communication unit 13 through a network. The location information acquisition unit 101 does not necessarily receive information from the portable terminal 2. The location information acquisition unit 101 may receive history information of location information via a storage medium, such as a universal serial bus (USB) memory, an SD card, or a digital versatile disc-ROM (DVD-ROM).

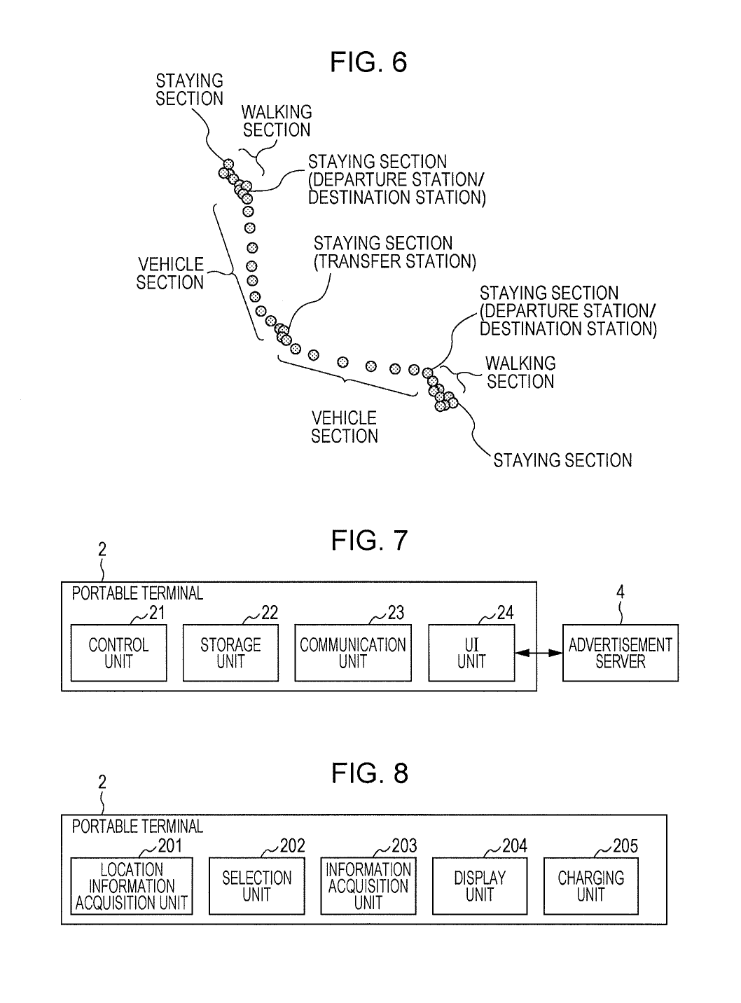

The selection unit 102 selects advertisement data corresponding to a region including the location of the portable terminal 2 identified from location information in the case where the moving speed of the portable terminal 2 is within a predetermined speed range. More specifically, the selection unit 102 calculates a moving speed from history information of location information acquired by the location information acquisition unit 101, categorizes location information for each specific speed range, and selects advertisement data to be acquired, based on the categorized location information. In the first exemplary embodiment, location information is categorized into three sections: a staying section in which the moving speed is within a speed range representing staying; a walking section in which the moving speed is within a speed range of walking; and a vehicle section in which the moving speed is within a speed range for vehicles. Advertisement data of regions close to locations represented by plural pieces of location information categorized as walking sections and staying sections is selected. FIG. 6 is a diagram illustrating an example of an analysis result of history information of location information.

Preferably, the degree of proximity to location information is different between walking sections and staying sections. For example, for a walking section, a region within a first distance from location information of the walking section is determined to be a target region for which advertisement data is to be acquired, so that advertisement data near the place where a user is walking may be acquired. For a staying section, a region within a second distance, which is longer than the first distance, from location information of the staying section is determined to be a target region for which advertisement data is to be acquired, so that advertisement data for a wider range than a walking section may be acquired.

In the case where vehicle sections exist before and after a staying section, the selection unit 102 selects advertisement data related to the staying section. More specifically, in the case where vehicle sections exist before and after a staying section, it is considered that a facility such as a transfer station exists in the staying section. Therefore, the staying section is determined to be a target region for which advertisement data related to a station is to be acquired.

The information acquisition unit 103 is a unit which retrieves and acquires advertisement data selected by the selection unit 102 from the advertisement DB 40. More specifically, the information acquisition unit 103 reads a record corresponding to a target region determined by the selection unit 102 (a region within the first distance from location information of a walking section and a region within the second distance from location information of a staying section) from the advertisement DB 40. Furthermore, for a target region for which advertisement data related to a station is to be acquired, a record in which the name of the station is stored as an attribute is read from among records in the advertisement DB 40 corresponding to the staying section.

The output unit 104 outputs plural pieces of advertisement data acquired by the information acquisition unit 103 to the printing device 3.

The printing unit 301 prints information corresponding to an instruction from a user of the portable terminal 2 and advertisement data selected by the selection unit 102. More specifically, the printing device 3 (including the control device 1) is installed at a convenience store or the like, and provides various services including printing. In the first exemplary embodiment, an image printing service via the Internet will be explained as an example of the various services. In the image printing service, a user transmits image data associated with authentication information (for example, a user identifier and a password) from a personal computer (PC) or the like at home to an external storage device via the Internet. Then, the user operates the printing device 3 installed at a convenience store to acquire the image data from the external storage device, and causes the printing device 3 to print an image represented by the image data. The image data is an example of information corresponding to an instruction from the user of the portable terminal 2. Furthermore, with this service, in addition to the image represented by the image data transmitted by the user, an image represented by advertisement data acquired from the advertisement DB 40 by using history information of location information is also printed.

The charging unit 105 charges a user of the portable terminal 2 when information corresponding to an instruction from the user is printed by the printing device 3. More specifically, the charging unit 105 subtracts the amount of money corresponding to advertisement data from the amount of money to be charged for printing of information corresponding to an instruction from the user, and charges the user the thus reduced amount of money. More specifically, the control unit 11 subtracts, for example, the amount of money obtained by multiplying the cost for an image printing service via the Internet by a predetermined discount rate from the cost for the image printing service, and causes the UI unit 33 to display the thus reduced amount of money. When the user inserts the corresponding amount of money into a money box, the image printing service via the Internet to which an advertisement service has been added is completed.

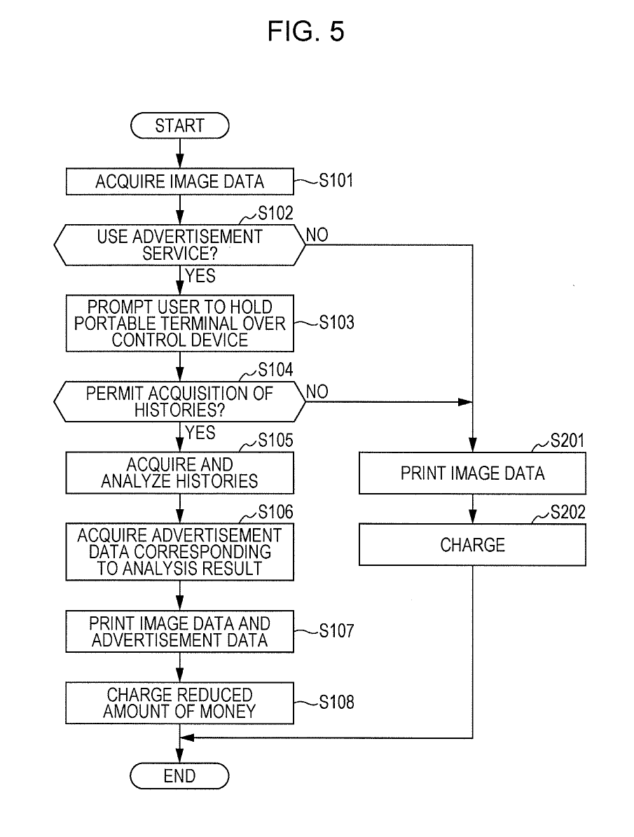

FIG. 5 is a flowchart illustrating an operation of the control device 1. The control unit 11 of the control device 1 performs a process described below in accordance with a procedure described in an application program stored in the storage unit 12. An operation explained below starts when a user inputs an instruction for an image printing service via the Internet to the printing device 3.

In step S101, the control unit 11 acquires image data. More specifically, the user inputs authentication information to the UI unit 33 of the printing device 3. The control unit 11 requests an external storage device to transmit image data corresponding to the authentication information. The external storage device transmits the image data corresponding to the authentication information to the control device 1. The control unit 11 receives the image data and stores the received image data into the storage unit 12.

In step S102, the control unit 11 queries the user as to whether or not to use an advertisement service. More specifically, the control unit 11 causes the UI unit 33 to display a sentence which explains the details of the advertisement service, a sentence, such as “Do you want to use an advertisement service?”, and “Yes” and “No” buttons. When the “Yes” button is depressed (Yes in step S102), the control unit 11 proceeds the process to step S103. When the “No” button is depressed (No in step S102), the control unit 11 proceeds the process to step S201.

In step S103, the control unit 11 prompts the user to hold the portable terminal 2 over the control device 1. More specifically, the control unit 11 causes the UI unit 33 to display a picture indicating the position of the short-distance wireless communication unit 14 and a sentence, such as “Please hold your smartphone, portable telephone, or the like over the indicated position.” When the user holds the portable terminal 2 over the position of the short-distance wireless communication unit 14, the control unit 11 proceeds the process to step S104.

In step S104, the control unit 11 queries the user as to whether or not to permit acquisition of history information of location information. More specifically, the control unit 11 causes the UI unit 33 to display a sentence, such as “Do you want to permit acquisition of histories of location information from your smartphone, portable telephone, or the like?”, and “Yes” and “No” buttons. When the “Yes” button is depressed (Yes in step S104), the control unit 11 proceeds the process to step S105. When the “No” button is depressed (No in step S104), the control unit 11 proceeds the process to step S201.

In step S105, the control unit 11 acquires and analyzes history information of location information. More specifically, the control unit 11 requests the portable terminal 2 for history information of location information via short-distance wireless communication. When receiving history information of location information from the portable terminal 2, the control unit 11 calculates moving speed by calculating the moving distance between two times temporally adjacent to each other in the history information of the location information and dividing the moving distance by the difference between the two times. Two thresholds are set for moving speed. A first threshold is the maximum moving speed for walking, and a second threshold is the minimum moving speed for walking. The control unit 11 determines a section in which the moving speed is equal to or more than the first threshold to be a section in which a user moves by vehicle (a train, a car, or the like) (hereinafter, referred to as a vehicle section). The control unit 11 determines a section in which the moving speed is less than the first threshold and equal to or more than the second threshold to be a section in which a user moves on foot (hereinafter, referred to as a walking section). The control unit 11 determines a section in which the moving speed is less than the second threshold to be a section in which a user stays (hereinafter, referred to as a staying section). Furthermore, in the case where vehicle sections exist before and after a staying section, the control unit 11 determines that a facility such as a transfer station exists within the staying section. FIG. 6 is a diagram illustrating an example of an analysis result of history information of location information.

In step S106, the control unit 11 acquires advertisement data corresponding to an analysis result. More specifically, the control unit 11 determines a region within the first distance from location information of a walking section to be a target region for which advertisement data related to the walking section is to be acquired. The control unit 11 also determines a region within the second distance, which is longer than the first distance, from location information of a staying section to be a target region for which advertisement data related to the staying section is to be acquired. Then, the control unit 11 acquires URLs corresponding to the determined target regions from the advertisement DB 40. When it is determined in step S105 that a facility such as a transfer station exists within the staying section, the control unit 11 acquires an URL corresponding to the name of the station.

In step S107, the control unit 11 prints the image data and the advertisement data. More specifically, the control unit 11 arranges images represented by the advertisement data in upper and lower margins of the image represented by the image data, and causes the printing device 3 to print the images.

In step S108, the control unit 11 charges the user a reduced amount of money. More specifically, the control unit 11 subtracts, for example, the amount of money obtained by multiplying the cost for the image printing service via the Internet by a predetermined discount rate from the cost for the image printing service, and causes the UI unit 33 to display the thus reduced amount of money. When the user inserts the corresponding amount of money into a money box, the image printing service via the Internet to which the advertisement service has been added is completed.

Meanwhile, in step S201, the control unit 11 causes the printing device 3 to print the image based on the image data acquired from the external storage device. In this case, since no advertisement data is acquired, no advertisement image is printed.

In step S202, the control unit 11 charges the cost for the image printing service via the Internet. In this case, a reduction of the amount of money corresponding to the advertisement service is not applied.

### Second Exemplary Embodiment

In a second exemplary embodiment, an example in which features of the above-described advertisement service are embedded in an application executed by the portable terminal 2 will be explained. A specific example will be described below.

FIG. 7 is a diagram illustrating a hardware configuration of the portable terminal 2. The portable terminal 2 includes a control unit 21, a storage unit 22, a communication unit 23, and an UI unit 24. The control unit 21 includes an arithmetic device, such as a central processing unit (CPU), and a storage device, such as a read only memory (ROM) and a random access memory (RAM) (neither devices are illustrated). Hardware and firmware in which a procedure of start-up of an operating system (OS) is described are stored in the ROM. The RAM is used to store data when the CPU performs arithmetic operations. The storage unit 22 includes, for example, a semiconductor memory, and stores therein an OS, an application program, and the like. The storage unit 22 also stores the history DB 20 as in the first exemplary embodiment. The communication unit 23 is a communication I/F which allows the portable terminal 2 to be connected to the advertisement server 4 via a mobile communication network. The UI unit 24 includes a display part and a reception part (not illustrated). The display part is, for example, a liquid crystal display, and displays an operation screen to be used by a user for operation of the portable terminal 2. The reception part is, for example, a touch panel provided to cover the display surface of the display part. The reception part receives an operation performed by a user and outputs the contents of the operation to the control unit 21.

The application program in the second exemplary embodiment provides services including mail-order sales and on-line games via the Internet, and a mechanism in which a user is charged the cost corresponding to the use contents through communication with a provider server via a mobile communication network and the Internet. At the time of installing the application program into the portable terminal 2, a screen which queries the user as to whether or not to permit recording of location information is displayed on the UI unit 24. When the user inputs data indicating permission for recording of location information into the UI unit 24, after the application program is installed, location information is recorded in the history DB 20 at predetermined time intervals by utilizing a known satellite positioning system and the like. Location information continues to be recorded until the application program is uninstalled.

FIG. 8 is a diagram illustrating a functional configuration of the portable terminal 2. The portable terminal 2 includes a location information acquisition unit 201, a selection unit 202, an information acquisition unit 203, a display unit 204, and a charging unit 205. The selection unit 202 and the information acquisition unit 203 are configured as in the first exemplary embodiment.

The location information acquisition unit 201 is a unit which acquires history information of location information indicating the location of the portable terminal 2. More specifically, the control unit 21 acquires history information of location information from the history DB 20 stored in the storage unit 22.

The display unit 204 displays plural pieces of advertisement data acquired by the information acquisition unit 203. More specifically, the control unit 21 outputs advertisement data retrieved and acquired from the advertisement DB 40 to the UI unit 24. The UI unit 24 displays the output advertisement data.

The charging unit 205 is a unit which charges a user when an application program designated by the user is executed by the portable terminal 2. In the case where the display unit 204 displays advertisement data at least one of before, during, and after execution of the application designated by the user, the charging unit 205 subtracts the amount of money corresponding to the advertisement data from the amount of money to be charged for the execution of the application program, and charges the user the thus reduced amount of money.

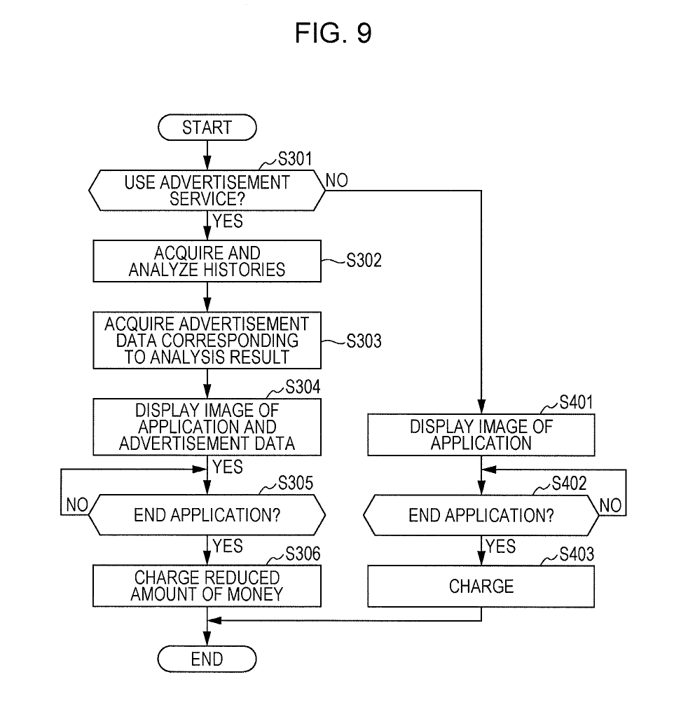

FIG. 9 is a flowchart illustrating an operation of the portable terminal 2. The control unit 21 of the portable terminal 2 performs a process described below in accordance with a procedure described in an application program stored in the storage unit 22. An operation explained below starts when a user instructs the portable terminal 2 to start execution of the application program.

In step S301, the control unit 21 queries the user as to whether or not to use an advertisement service. More specifically, the control unit 21 causes the UI unit 24 to display a sentence which explains the details of the advertisement service, a sentence, such as “Do you want to use an advertisement service?”, and “Yes” and “No” buttons. When the “Yes” button is depressed (Yes in step S301), the control unit 21 proceeds the process to step S302. When the “No” button is depressed (No in step S301), the control unit 11 proceeds the process to step S401.

In step S302, the control unit 21 acquires and analyzes history information of location information. More specifically, the control unit 21 reads history information of location information from the history DB 20 stored in the storage unit 22, and categorizes the location information into a walking section, a staying section, and a vehicle section, by processing similar to step S105 in the first exemplary embodiment.

In step S303, the control unit 21 acquires advertisement data corresponding to an analysis result by processing similar to step S106 in the first exemplary embodiment.

In step S304, the control unit 21 displays a screen of the application program and the advertisement data. More specifically, the control unit 21 arranges advertisements represented by the advertisement data in upper and lower margins on the screen of the application program of the UI unit 24, and displays the advertisements. The advertisements may continue to be displayed during the execution of the application program or may be displayed during a limited time. Plural advertisements may be sequentially displayed by switching. A displayed advertisement may be transmitted to the printing device 3 and printed.

In step S305, the control unit 21 determines whether or not an instruction for termination of the application program has been input. When such an instruction is input (Yes in step S305), the control unit 21 proceeds the process to step S306.

In step S306, the control unit 21 reduces the use fee for the application program and charges the reduced amount of money. More specifically, the control unit 21 subtracts, for example, the amount of money obtained by multiplying the use fee for the application program by a predetermined discount rate from the use fee, and causes the UI unit 24 to display the thus reduced amount of money. The control unit 21 also transmits charging data indicating the displayed amount of money to a provider server via a mobile communication network and the Internet.

Meanwhile, in step S401, the control unit 21 causes the UI unit 24 to display a screen of the application program. In this case, advertisement data is not displayed.

In step S402, the control unit 21 determines whether or not an instruction for termination of the application program has been input. When such an instruction is input (Yes in step S402), the control unit 21 proceeds to the process to step S403.

In step S403, the control unit 21 charges the use fee for the application program. In this case, a reduction of the amount of money corresponding to the advertisement service is not applied.

### Modifications

The foregoing exemplary embodiments may be modified as described below. Furthermore, plural modifications may be combined together.

In the foregoing exemplary embodiments, an example in which a region within the second distance from location information of a staying section is determined to be a target region for which advertisement data related to the staying section is to be acquired has been explained. However, by increasing the second distance in accordance with the increase in the stay period in the staying section, a target region for advertisement data may be expanded accordingly as the stay time in the staying section becomes longer.

A type of advertisement data corresponding to the length of the stay period in a staying section may be acquired. For example, each record in the advertisement DB 40 may be associated with the type of an advertisement (fast-food restaurants, movie theaters, or the like). In the case where the stay period is shorter than thirty minutes, advertisement data of fast-food restaurants may be acquired. In the case where the stay period is two hours or longer, advertisement data of movie theaters may be acquired.

A type of advertisement data corresponding to the time and day of the week when a user utilizes an advertisement service may be acquired. For example, during a morning commute hours, advertisement data of fast-food restaurants may be acquired. During the daytime on Saturdays and Sundays, advertisement data of movie theaters may be acquired.

Advertisement data corresponding to the location of the portable terminal 2 at the time when the user utilizes an advertisement service may be acquired. For example, location information of the portable terminal 2 at the time when the user utilizes the advertisement service may be acquired, so that advertisement data related to a region close to a location represented by the location information may be acquired from among plural pieces of advertisement data acquired in accordance with the procedure described in the foregoing exemplary embodiments.

A type of advertisement data corresponding to the moving speed of the portable terminal 2 at the time when a user utilizes an advertisement service may be acquired. For example, the moving speed is calculated from location information for plural number of times immediately before the time when the user utilizes the advertisement service. A user's moving method (on foot, a train, a car, an airplane, or the like) may be determined based on the moving speed, and a type of advertisement data corresponding to the moving method may be acquired. For example, in the case of moving by train, advertisement data of stores in a transfer station may be acquired. In the case of moving by car, advertisement data of stores with parking spaces, gas stations, roadside stations, and the like may be acquired. In the case of moving by airplane, advertisement data of souvenir shops in an airport may be acquired.

Furthermore, by comparing railroad/bus line information with location information of the portable terminal 2, a user's moving method may be determined.

By analyzing history information of location information, the frequency of appearance of the same walking section, the same staying section, and the same vehicle section may be obtained, and advertisement data of a section with a higher frequency may be acquired preferentially. Furthermore, a section with a frequency of appearance higher than a threshold is compared with the location of the portable terminal 2 at the time when a user utilizes an advertisement service. When the distance between the section and the location of the portable terminal 2 exceeds a threshold, the user may on a holiday or business trip. Therefore, advertisement data of souvenir shops and tourist spots may be acquired.

History information of advertisement data printed in the advertisement service may be stored, and advertisement data other than previously acquired advertisement data may be acquired preferentially.

In the foregoing exemplary embodiments, an example in which advertisement data is acquired as regional information is explained. However, regional information other than advertisement data may be acquired. For example, a coupon for providing a customer with a right to receive a discount service and the like may be acquired. Furthermore, information related to disaster prevention and crime prevention in a region, weather information in a region, and the like may be acquired. Furthermore, in the second exemplary embodiment, a screen on which acquired regional information is displayed may be stored in the storage unit 22 of the portable terminal 2, and the screen may be displayed on the UI unit 24 in accordance with a user operation.

In the first exemplary embodiment, an example in which images represented by advertisement data are arranged in upper and lower margins of an image represented by image data is explained. However, an image represented by advertisement data may be printed on the rear side of a sheet on which an image represented by image data is printed. Furthermore, an image represented by advertisement data may be printed on a sheet different from a sheet on which an image represented by image data is printed. Furthermore, only an image represented by image data may be printed on a sheet, and an image represented by advertisement data may be displayed on the UI unit 33. Furthermore, a user may select any of the above forms, and the discount rate corresponding to the selected form may be applied.

In the foregoing exemplary embodiments, an example in which an advertisement service is added to an image printing service via the Internet is explained. However, in the case where the printing device 3 has a copying function, an advertisement service may be added to a copying service.

In the second exemplary embodiment, an example in which the portable terminal 2 includes the charging unit 205 is explained. However, the charging unit 205 may be provided in a provider server of an application program. For example, when an instruction for termination of an application program is input in step S305 (Yes in step S305), the control unit 21 notifies the server that the advertisement service has been used, and the charging unit 205 of the server charges a reduced amount of money. Meanwhile, when an instruction for termination of an application program is input in step S402 (Yes in step S402), the control unit 21 notifies the server that the advertisement service has not been used, and the charging unit 205 of the server charges without reducing the amount of money. Alternatively, use or non-use of an advertisement service may be registered to a provider server at the time when an application program is installed, and the server charges the amount of money corresponding to the registered contents.

In the foregoing exemplary embodiments, an example in which the history DB 20 is stored in the portable terminal 2 is explained. However, the history DB 20 may be stored in an external storage device, and the control device 1 (first exemplary embodiment) or the portable terminal 2 (second exemplary embodiment) may acquire history information of location information from the history DB 20.

In the first exemplary embodiment, an example in which the control device 1 includes the information acquisition unit 103 is explained. However, a function of the information acquisition unit 103 may be provided in an external server (for example, the advertisement server 4). In this case, the advertisement server 4 retrieves and acquires advertisement data corresponding to a target region determined by the selection unit 102 of the control device 1 from the advertisement DB 40, and transmits the acquired advertisement data to the control device 1.

In the second exemplary embodiment, an example in which the portable terminal 2 includes the information acquisition unit 203 is explained. However, a function of the information acquisition unit 203 may be provided in an external server (for example, the advertisement server 4). In this case, the advertisement server 4 retrieves and acquires advertisement data corresponding to a target region determined by the selection unit 202 of the portable terminal 2 from the advertisement DB 40, and transmits the acquired advertisement data to the portable terminal 2.

In the first exemplary embodiment, the control device 1 may be separated from the printing device 3.

In the foregoing exemplary embodiments, an example in which the control unit 11 or the control unit 21 executes an application program to implement the functions described above is explained. However, the functions described above may be implemented using a hardware circuit in the control device 1 or the portable terminal 2. Furthermore, the program may be recorded on and supplied to a computer-readable recording medium, such as an optical recording medium or a semiconductor memory. The program may be read from the recording medium and installed into the control device 1 or the portable terminal 2. Furthermore, the program may be supplied via an electric communication line.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control device comprising:
a selection unit that selects, based on location information of a portable terminal and information of a moving speed of the portable terminal, regional information related to a region represented by the location information.

2. The control device according to claim 1, wherein in a case where the moving speed is within a predetermined speed range, the selection unit selects regional information corresponding to a region including a location of the portable terminal identified from the location information.

3. The control device according to claim 1, wherein the selection unit identifies, from the location information, a walking section in which the moving speed is within a speed range of walking, and selects regional information related to the walking section.

4. The control device according to claim 1, wherein the selection unit identifies, from the location information, a staying section in which the moving speed is within a speed range indicating staying, and selects regional information related to the staying section.

5. The control device according to claim 4, wherein the selection unit expands a target region of the regional information as a staying time in the staying section becomes longer.

6. The control device according to claim 4, wherein the selection unit selects a type of regional information according to a length of a staying time in the staying section.

7. The control device according to claim 4, wherein the selection unit identifies a vehicle section in which the moving speed is within a speed range for vehicles, and when vehicle sections exist before and after the staying section, the selection unit selects regional information related to the staying section.

8. The control device according to claim 1, wherein the selection unit selects a type of regional information according to a time at which the selection is made.

9. The control device according to claim 1, further comprising:
a printing unit that prints regional information selected by the selection unit.

10. The control device according to claim 9, further comprising:
a charging unit that charges, when information corresponding to an instruction from a user of the portable terminal is printed by the printing unit, the user an amount of money,
wherein the printing unit prints the information corresponding to the instruction from the user of the portable terminal and the regional information selected by the selection unit, and
wherein the charging unit charges the user an amount of money obtained by subtracting an amount of money corresponding to the regional information from an amount of money to be charged for printing of the information.

11. A portable terminal comprising:
a selection unit that selects, based on location information of the portable terminal and information of a moving speed of the portable terminal, regional information related to a region represented by the location information; and
a display that displays regional information selected by the selection unit.

12. The portable terminal according to claim 11, wherein in a case where the moving speed is within a predetermined speed range, the selection unit selects regional information corresponding to a region including a location of the portable terminal identified from the location information.

13. The portable terminal according to claim 11, further comprising:
an execution unit that executes a program designated by a user of the portable terminal; and
a charging unit that charges the user when the program is executed by the execution unit,
wherein in a case where the display displays the regional information at least one of before, during, and after execution of the program, the charging unit charges the user an amount of money obtained by subtracting an amount of money corresponding to the regional information from an amount of money to be charged for the execution of the program.

14. A non-transitory computer readable medium storing a program causing a computer to execute a process for control, the process comprising:
selecting, based on location information of a portable terminal and information of a moving speed of the portable terminal, regional information related to a region represented by the location information.

15. The computer readable medium according to claim 14, wherein in a case where the moving speed is within a predetermined speed range, selecting regional information corresponding to a region including a location of the portable terminal identified from the location information.
